(19) United States
(12) Patent Application Publication
(10) Pub. No.: US 2004/0188014 A1
(43) Pub. Date: Sep. 30, 2004

(54) Method and device for jointing of cores

(76) Inventors: Kjell Johanson, Falkenberg (SE); Goran Ljungek, Holm (SE)

Correspondence Address: MCGINN & GIBB, PLLC, 8321 OLD COURTHOUSE ROAD, SUITE 200, VIENNA, VA, 22182-3817, US

(21) Appl. No.: 10/482,842

(22) PCT Filed: Jul. 2, 2002
(86) PCT No.: PCT/SE02/01319

(30) Foreign Application Priority Data
Jul. 5, 2001 (SE) 0102452-0

(51) Int. Cl. B65H 75/50; B31C 13/00

(52) U.S. Cl. 156/304.2; 156/304.1; 156/502

(57) ABSTRACT

The present invention relates to a method of joining sleeves, e.g. paperboard sleeves, which within the paper industry are employed for rolling up manufactured paper webs, wheets webs or the like, in which at least the one joint surface is provided with a first glue strand of a glue of such properties that the glue gives an immediate fixing of the joint parts and said at least one joint surface is provided with a second glue strand of a glue of such properties that the sleeve material in the joint surface and its immediate vicinity are wetted, and thereafter sets, e.g. by drying. The present invention further relates to an apparatus for carrying the method into effect, in which the one sleeve (2) is placed in a first alignment device (16), that the other sleeve (1) is placed in a second alignement device (17) in which the alignment devices (16, 17) are positioned for aligning the axes of the sleeves (1, 2) with one another, at which a first nozzle (M5) for the first glue strand (5) is provided at the joint surface on at least the one sleeve (1) for applying the first glue strand (5) and in which a second nozzle (M6) for the second glue strand (6) is provided at the joint surface on at least said one sleeve (1) for aplying the second glue strand (6).

The present invention relates to a method according to the preamble to claim 1. Further, the present invention relates to an apparatus for carrying the method into effect.

Within, among others, the paper industry, there has become a steadily increasing need to be able to join sleeves of, above all, paperboard in order to be able to reuse sleeves which would otherwise be scrapped. However, extremely strict demands are placed on the quality of the joined sleeves. This relates in particular to the joint itself which must be strong (show considerable mechanical strength in all axes) and which must keep the sleeve sections aligned with one another and with correct roundness. The mechanical strength requirements are particularly large since a sleeve breakage can lead to serious accidents with both personal injuries and serious damage to machinery.

The task forming the basis of the present invention is to realise a novel method and a novel apparatus for joining sleeves of the type disclosed by way of introduction.

This task is solved according to the present invention in that the method disclosed by way of introduction is given the characterising features in appended claim 1. An apparatus according to the present invention is given the characterising features according to appended claim 8.

Through the present invention, there will be realised a method of joining sleeves, whereby the joints display extraordinary mechanical strength and great accuracy as regards alignment and roundness. The method according to the present invention also permits the realisation of a simple and reliable apparatus for carrying out the method. An apparatus according to the present invention permits a high degree of automation

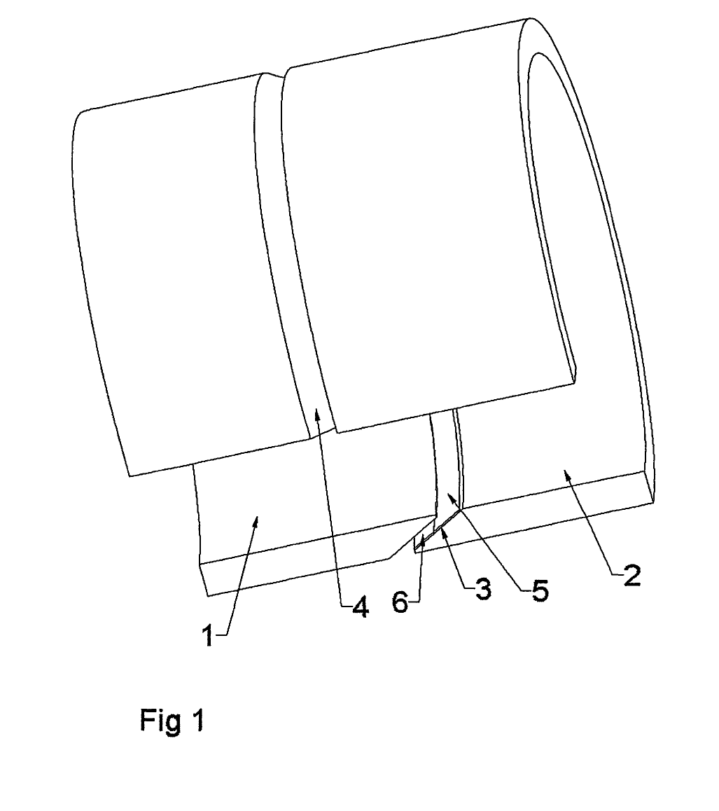

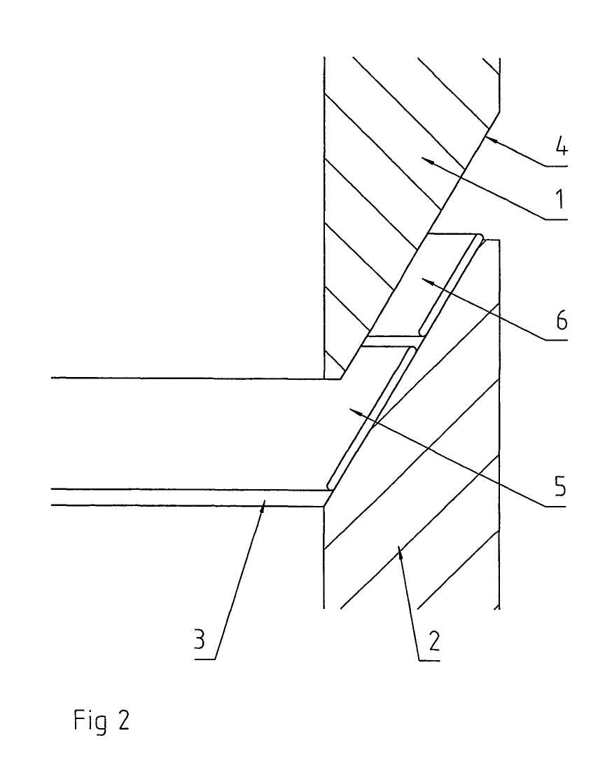

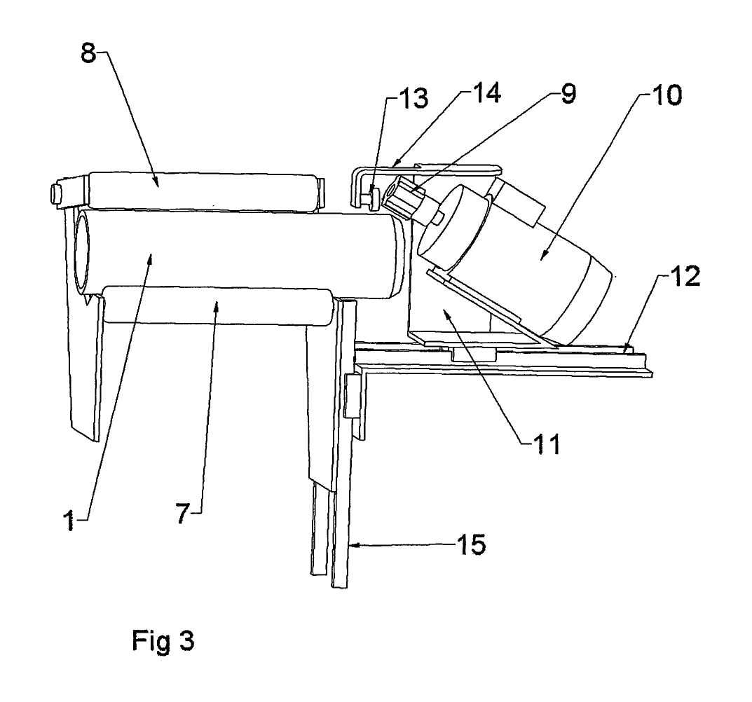

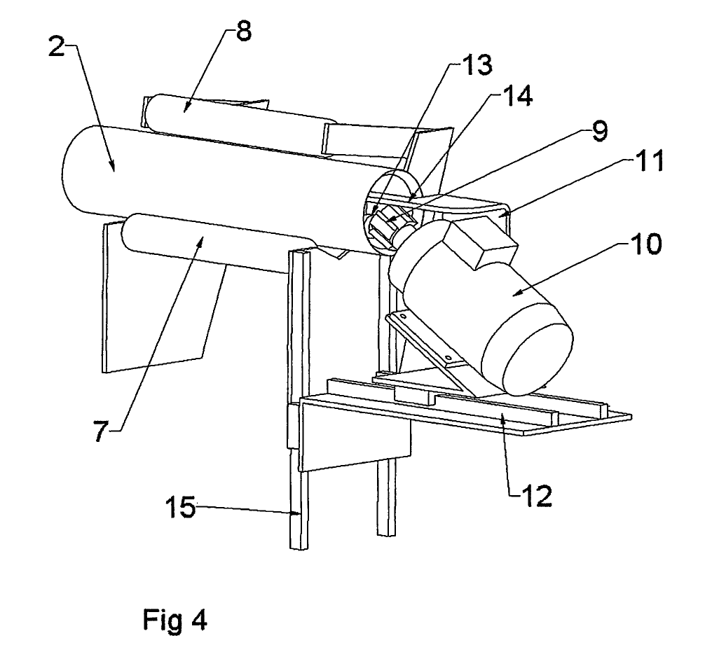

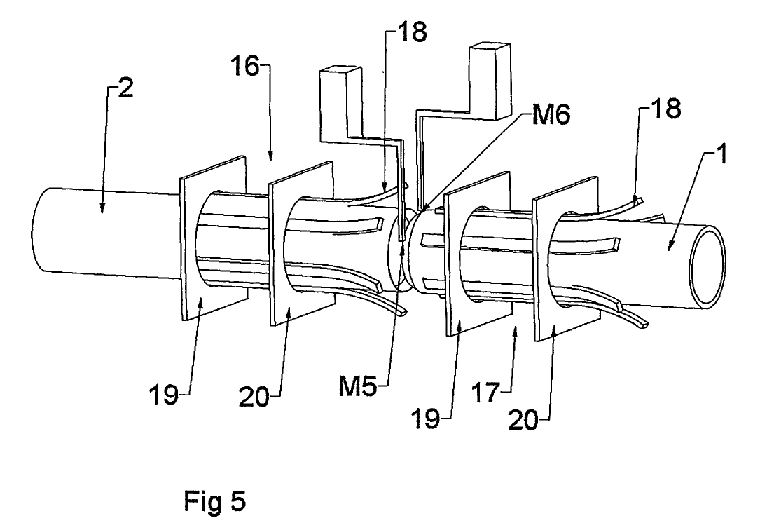

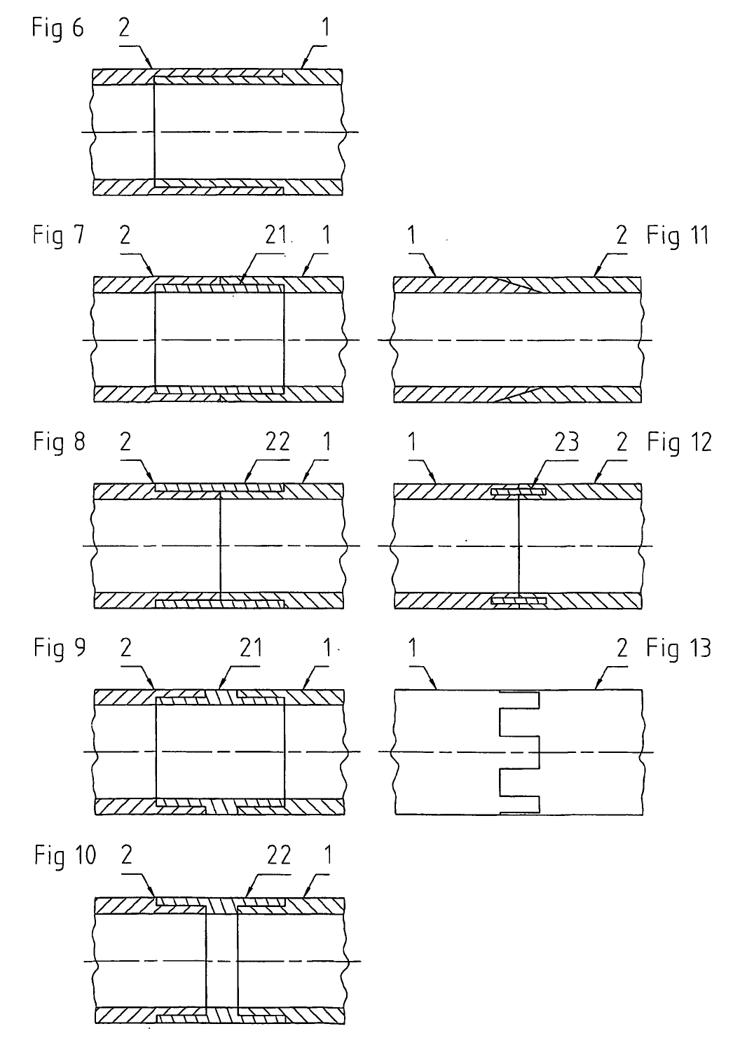

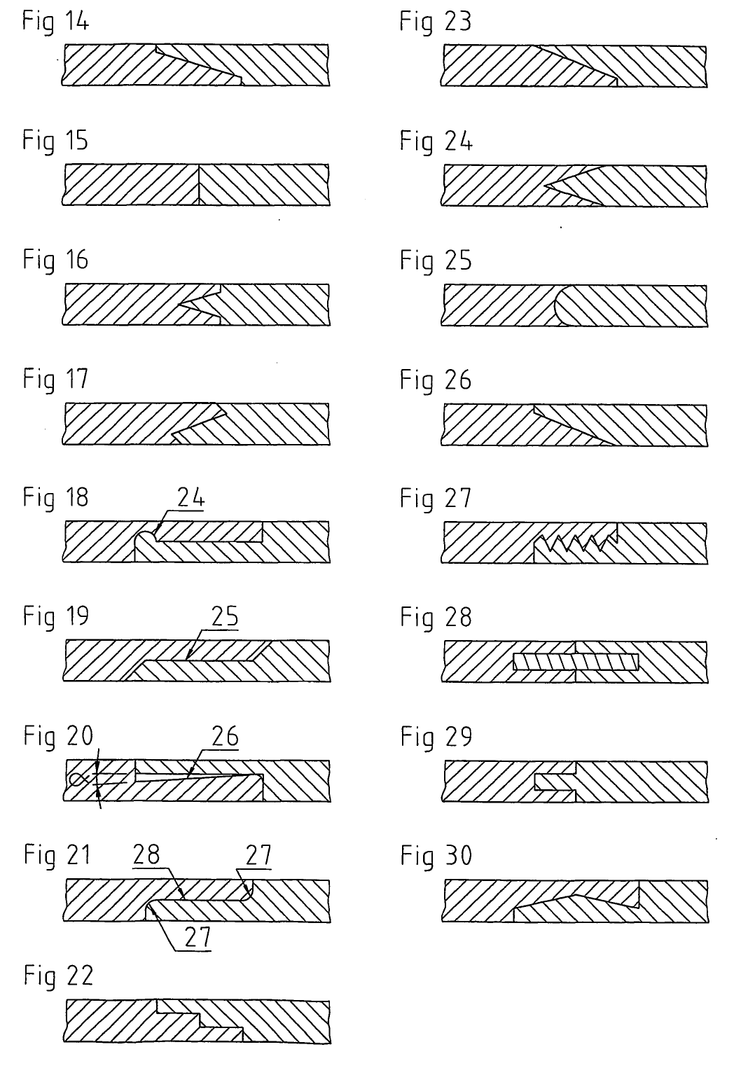

The present invention will be described in greater detail hereinbelow with reference to the accompanying drawings. FIG. 1 shows a schematic view of a future joint between two sleeves, parts having been broken away for purposes of clarity. FIG. 2 shows on a large scale a view partly in section of a part of the future joint in FIG. 1. FIG. 3 shows a view of a part of an apparatus for realising the joint in FIG. 1 and 2. FIG. 4 shows a view of the apparatus in FIG. 3 under execution of another work phase. FIG. 5 shows a view of another part of an apparatus for realising the joint in FIG. 1 and 2. FIG. 6-12 show cross sections of different types of joints. FIG. 13 shows a view of a joint. FIG. 14-30 show simplified cross sections of different types of joints.

In the different drawing figures, the same parts have been given the same reference numeral. In FIG. 1 parts are exemplified of two paperboard sleeves 1 and 2 which are to be joined together to one another. In this case, the sleeve 2 is provided with an inner conical surface 3, while the sleeve 1 is provided with an outer conical joint surface 4. On the conical joint surface 3 there is applied a first glue strand 5 and a second glue strand 6. The glue strand 5 may consist of a melt glue, while the glue strand 6 consists of a dispersion glue. It is also possible to cause the glue strand 5 to consist of a dispersion glue, while the glue strand 6 in such case consists of a melt glue.

For achieving a good joint quality, it has proved to be particularly important that the one glue strand consists of a glue of such properties that it gives an immediate fixing after closure of the joint in that the sleeves 1 and 2 are moved towards one another and exercising of a suitable compression pressure. One such glue is a melt glue. If the one glue strand, e.g. 5, consists of a melt glue, it is suitable that the other glue strand consist of a glue which has such properties that the glue wets the sleeve material and penetrates in between the fibres and sets, for example, by drying. Such properties possess a dispersion glue or PVA glue.

The primary duty of the melt glue strand is to fix the two sleeve parts 1 and 2 into a unit, which can be transported and after-processed by, for example, cleaning. The dispersion glue joint serves substantially to impart, after setting, the mechanical strength which is sought for use of the sleeve formed by the sleeve parts 1 and 2.

The glue strand 5, 6 need not necessarily be continuous but may be discontinuous. Further, the one glue strand may be discontinuous and the other continuous. In the case when both glue strands are discontinuous, it may be appropriate that the glue sections of the one glue strand cover the spaces between the glue sections in the other glue strand.

FIG. 2 shows, on a large scale, a part of the glue joint of FIG. 1.

In FIGS. 3, 4 and 5, are shown parts of an apparatus for realising a joint of the type illustrated in greater detail in FIG. 1 and 2. FIG. 3 shows the sleeve section 1 placed on two rollers 7 which are placed side by side, only the one roller being apparent in the figure. Above the rollers 7 and the sleeve 1, there is disposed an additional roller 8 which serves to hold the sleeve 1 on the rollers 7 or to urge the sleeve 1 against the rollers 7. Possibly, the roller 8 may be utilised for rotation of the sleeve 1 on the rollers 7. It also conceivable to provide a separate drive means for rotation of the sleeve 1 in the roller package formed by the rollers 7 and 8.

At the end of the sleeve section 1, there is disposed a miller 9 which is driven by a motor 10 and which is placed at an angle to the sleeve 1 for processing the sleeve end edge in the desired angle for realising the joint surface 4 which is shown in FIG. 1 and 2. The miller 9 and the motor 10 are disposed on a carriage 11 which is displaceable on a sliding rail 12 in the longitudinal direction of the sleeve 1. The carriage 11 supports a support roller 13 which is positioned on the end of an arm 14 which extends out from the carriage 11. The sliding rail 12 is displaceable at right angles to the sleeve 1 on a sliding rail 15 at right angles in relation to the sliding rail 12. The sliding rail 12 and the carriage 11 may be adjustable with the aid of a gear rack, thread spindle or the like.

FIG. 4 illustrates substantially the same apparatus as in FIG. 3, but with the parts in position for processing the sleeve section 2 and realising the joint surface 3, which implies that the inside of the sleeve section 2 is processed with the aid of the miller 9. Thus, the same apparatus may be employed for processing both the sleeve section 1 and the sleeve section 2 for creating, on the one hand, the female surface 3 and, on the other hand, the male surface 4.

After the processing of the sleeve sections 1 and 2 described in connection with FIG. 3 and 4 for forming the joint surfaces 3 and 4, the sleeve sections 1 and 2 are to be aligned accurately with one another and this may be carried into effect with the aid of the alignment devices 16 and 17 shown in FIG. 5. As is apparent from FIG. 5, the alignment devices 16 and 17 are substantially identical and display a number of guide rails 18 which extend between two support walls 19 and 20, the guide rails 18 being outwardly bent at the one end in order to facilitate insertion of the sleeve sections 1 and 2. After the insertion of the sleeve sections 1 and 2 in the alignment devices 16 and 17, the alignment devices may be displaced to the position illustrated in FIG. 5 in which the longitudinal axes of the sleeve sections 1 and 2 are aligned with one another. This alignment of the alignment devices may naturally take place mechanically on some form of machine bed using rails or the like. At the joint formed between the sleeve sections 1 and 2 there is provided a nozzle MS for application or coating of the glue strand 5 and a nozzle M6 for application of the glue strand 6. The nozzles MS and M6 can be given a substantially optional positioning which is appropriate in the different individual cases. As was mentioned above, the one nozzle MS serves for application of melt glue while the other nozzle M5 serves for application of a dispersion glue. The nozzles M5 and M6 are each connected to their glue container via a suitable valve (not shown) for regulating the supply of glue to the glue strands on the joint surface or joint surfaces.

After the application of the glue strands, the alignment devices are displaced towards one another, or the one sleeve section 1 is displaced into the other sleeve section 2 which, in such an event, is held fixed against axial movement. The compression pressure may be determined empirically and thereafter all joints can be pressed together with exactly the same compression pressure.

FIGS. 6-13 exemplify a number of joints. FIG. 6 shows a cylindrical male and female joint. In FIG. 7 is shown a joint with an insert 21. FIG. 8 shows a joint with a special outer portion 22. FIG. 9 shows a joint with a specially formed insert 21. FIG. 10 shows a joint with a specially formed outer portion 22. In FIG. 11 is shown a similar joint to FIG. 1 and 2. FIG. 12 shows a special joint where the end surfaces of the sleeve sections 1 and 2 are straight or at right angles to the longitudinal axis of the sleeve sections 1, 2 and there a number of holes have been drilled axially in each sleeve section for the insertion of pins 23. FIG. 13 shows a further joint with toothed form. One advantage with the sleeve joints in FIG. 7, 8, 9, 10, 12 and 13 is that the ends of the sleeve sections are processed in substantially the same way.

FIG. 14-30 exemplify a further additional number of joint forms. FIG. 14 shows a conical joint with an outer and an inner planar support surface. FIG. 15 shows only a straight joint. FIG. 16 shows an arrowhead joint with a support surface. FIG. 17 shows a Z joint. FIG. 18 shows a joint with a bead 24. FIG. 19 shows a joint with a planar portion between oblique surfaces 25. FIG. 20 shows a joint with an angled portion 26 which makes an angle with the longitudinal axis of the sleeve sections. FIG. 21 shows a joint with rounded-off ends and planar central portion. FIG. 22 shows an echelon joint. FIG. 23 shows a conical joint with inner support surface. FIG. 24 shows a tipped joint. FIG. 25 shows a rounded-off joint. FIG. 26 shows a conical joint with outer support surface corresponding to the joint in FIG. 23. FIG. 27 shows a toothed/or threaded joint. FIG. 28 shows a plug joint. FIG. 29 shows a tongued and grooved joint. FIG. 30 shows a joint with gable top surfaces.

It is also possible to place the one glue strand 5 on the one joint surface 3 and the other glue strand 6 on the other joint surface 4. It is further possible to make many other combinations and distributions of the glue strands 5 and 6 on the joint surfaces 3 and 4. In the apparatus illustrated in FIG. 5, the rails 18 may be replaced by or combined with wheels and/or rollers.

Many modifications are naturally possible without departing from the inventive concept as defined in the appended claims.

1. Method of joining sleeves, e.g. paperboard sleeves which, in the paper industry, are employed for rolling up a manufactured paper web, sheet web or the like, characterised characterized in that at least the one joint surface is provided with a first glue strand of a glue of such properties that the glue gives an immediate fixing of the joint parts and that said at least one joint surface is supplied with a second glue strand of a glue of such properties that the sleeve material in the joint surface and its immediate vicinity are wetted and thereafter sets, e.g. by drying.

2. Method according to claim 1, characterised characterized in that the first glue strand consists of a melt glue.

3. Method according to claim 1, characterised characterized in that the second glue strand consists of a dispersion glue.

4. Method according to claim 1, characterised characterized in that the first glue strand is applied to the joint surface in the proximity of the outside of the joint surface, while the second glue strand is applied in the vicinity of the inside of the joint surface.

5. Method according to claim 1 or 4, characterised characterized in that the first glue strand and/or the second glue strand are applied discontinuously.

6. Method according to claim 5, characterised characterized in that the first glue strand is placed discontinuously and that the second glue strand is applied discontinuously with displacement in relation to the first glue strand.

7. Method according to claim 6, characterised characterized in that the two glue strands are applied offset in relation to each other so that the elements included in the glue strands cover the spaces between the glue sections in the glue strands.

8. Apparatus for carrying out the method according to claim 1, characterised characterized in that the one sleeve (2) is placed in a first alignment device (16), that the second sleeve (1) is placed in a second alignment device (17), that the alignment devices (16, 17) are positioned for aligning the axes of the sleeves (1, 2) with one another, that the first nozzle (M5) for the first glue strand (5) is disposed at the joint surface on at least the one sleeve (1) for application of the first glue strand (5); and that a second nozzle (M6) for the second glue strand (6) is provided at the joint surface on at least said one sleeve (1) for application of the second glue strand (6).

9. Apparatus according to claim 8, characterised characterized in that the alignment devices comprise a number of rails (18) and/or rollers and/or wheels.

10. Apparatus according to claim 9, characterised characterized in that at least the rails (18) extend in the longitudinal direction of the sleeve (1, 2) and are disposed with spacing around the circumference of the sleeve (1, 2).

11. Method according to claim 4, characterized in that the first glue strand and/or the second glue strand are applied discontinuously.
